(19) United States
(12) Patent Application Publication
(10) Pub. No.: US 2013/0166404 A1
(43) Pub. Date: Jun. 27, 2013

(54) MERCHANDISE TRADING SYSTEM AND METHOD

(71) Applicant: LITTLE BLACK BAG, INC., Los Angeles, CA (US)

(72) Inventors: David Weissman, Los Angeles, CA (US); Daniel Murillo, Los Angeles, CA (US); Pradyumna Siddhartha, Los Angeles, CA (US)

(73) Assignee: LITTLE BLACK BAG, INC., Los Angeles, CA (US)

(21) Appl. No.: 13/723,512

(22) Filed: Dec. 21, 2012

Related U.S. Application Data
(60) Provisional application No. 61/579,077, filed on Dec. 22, 2011.

(51) Int. Cl. G06Q 30/06

(52) U.S. Cl. CPC G06Q 30/0605
USPC 705/26.4

(57) ABSTRACT

A merchandise trading system and method is disclosed. In one embodiment, a server may randomly assign inventory items to a plurality of customers and notify the customers of which items they have been assigned. The server may provide an interface by which the customers may negotiate trades of assigned items. At the end of a trading session, the items may be distributed to the customers to whom the items are assigned at the end of the trading session. The server may assign items in a random manner, or items may be assigned such that each customer receives a set of items with a minimum value. The server may provide an interface by which customers may select one or more items that are assigned to them to carry those selected items over to another trading session.

### RELATED APPLICATIONS

This application claims the benefit of priority to U.S. Pat. App. No. 61/579,077, titled “MERCHANDISE TRADING SYSTEM AND METHOD,” filed Dec. 22, 2011, the disclosure of which is incorporated by reference in its entirety.

### BACKGROUND

As Internet access has become ubiquitous, consumers are increasingly comfortable with shopping online. Unlike retail establishments that often have high overhead due to the need to have a physical location and staff to interact with customers, online businesses present a relatively low barrier to entry. This has resulted in an explosion in the number of online retailers. In order to separate themselves from competitors, these retailers typically offer a particular value proposition for customers that shop at their site. Some businesses offer flash sales, subscription services, or invitation-only events. Others cater to a particular user demographic or product niches.

One merchandising technique that physical retailers use is the practice known in Japan as “Fukubukuro” or, translated, “Lucky Bag.” In this practice, consumers purchase mystery bags that contain a selection of items that are guaranteed to have a certain minimum total Manufacturer's Suggested Retail Price (MSRP). These items are typically clearance items from the previous fashion season or model year. Included among these mystery bags, the retailers may also randomly include a high value item, such as a sought-after piece from the upcoming fashion season. Some customers purchase these lucky bags and then attend parties with friends, where they trade unwanted items to obtain items they desire from their friends' bags.

The practice of selling these lucky bags is limited in a variety of manners. Customers must organize group shopping trips to purchase the bags and trade items, or they will be limited to the items they receive in their personal bag. Scheduling problems may make these group shopping trips problematic. Items must be physically placed within the bags, adding overhead costs to retailers. Physical retail establishments require owners to front the costs of rent and utilities, and introduce risks such as the possibility of shoplifters. Therefore, there is a need for a merchandise trading system and method to eliminate these issues and streamline the shopping process.

### SUMMARY

Aspects of the disclosure provide on online or computer-implemented merchandise trading system and method. A server may randomly assign inventory items to a plurality of customers and notify the customers of which items they have been assigned. The server may provide an interface by which the customers can negotiate trades of assigned items. At the end of a trading session, the items may be distributed to the customers to whom the items are assigned at the end of the trading session. The server may assign items in a random manner, or items may be assigned such that each customer receives a set of items with a minimum MSRP value. The server may randomly assign one or more special items that belong to a separate category from the rest of the inventory items. The server may provide an interface by which customers may select one or more items that are assigned to them to carry those selected items over to another trading session.

In one embodiment of the method, the method includes assigning, using a processor, a first plurality of items selected from an item inventory to a plurality of users, wherein each user is assigned at least one item from the first plurality of items and storing item assignment data, the item assignment data identifying which items of the first plurality of items are assigned to each of the plurality of users. The method may also include providing, with the processor, an interface that allows a first user of the plurality of users to trade a first item of the first plurality of items assigned to the first user with a second item of the first plurality of items assigned to a second user of the plurality of users and updating, with the processor, the item assignment data to reassign the first item and the second item based on the trade between the first user and the second user. The method may further include distributing the plurality of items to the users to whom the first plurality of items are assigned as designated by the item assignment data.

In another embodiment of the method, the first plurality of items may be distributed after the close of a designated trading period.

In a further embodiment of the method, the at least one item assigned to the first user may be designated by the first user to not be distributed to the first user, and instead be carried over to a next trading period.

In yet another embodiment of the method, the method may include assigning, with the processor, a second plurality of items selected from the item inventory to a first group of purchasable items, the first group of purchasable items having a discounted purchase price based on the total price of the first group of purchasable items, and assigning, with the processor, the first group of purchasable items to the first user based on a request by the first user to purchase the first group of purchasable items. The method may also include distributing the items of the first group of purchasable items to the first user.

In yet a further embodiment of the method, the items of the first group of purchasable items may be distributed to the first user after the close of a designated trading period, a length of the designated trading period being based on the discounted purchase price of the first group of purchasable items.

In another embodiment of the method, the trade between the first user and the second user is based on an identification of the second item by the first user as an item the first user is willing to trade for the first item.

In a further embodiment of the method, the trade between the first user and the second user may be based on an identification by the first user that the second user is a user the first user would like to trade with.

In yet another embodiment of the method, the first user may receive a plurality of trade offers for the first item, and the method may further include transferring, with the processor, the plurality of trade offers for the first item from the first user to the second user based on the trade between the first user and the second user of the first item for the second item.

In yet a further embodiment of the method, the method may include receiving, with the processor, a counter-offer from the second user to the first user based on the trade between the first user and the second user, wherein the counter-offer comprises an additional item for the first user to provide in order to complete the trade between the first user and the second user, and receiving, with the processor, an acknowledgement from the first user to complete the trade with the second user based on the counter-offer from the second user.

In another embodiment of the method, the additional item may include a virtual currency amount, the virtual currency being redeemable by the second user

In a further embodiment of the method, the method may include assigning, with the processor, a predetermined number of trades to the first user, wherein the predetermined number of trades is based on an initial purchase amount received from the first user, increasing, with the processor, the number of trades assigned to the first user based on a second purchase amount received from the first user, and decreasing, with the processor, the number of trades assigned to the first user based on the trade of the first item for the second item.

In yet another embodiment of the method, the method may include receiving a purchase amount from the first user to display a trade request with a predetermined feature for the second item, and displaying the trade request with the predetermined feature to the second user.

In yet a further embodiment of the method, the predetermined feature may include displaying the trade request at a specified location on a display of the second user.

In one embodiment of the disclosed system, the system may include an interface configured to receive communications from a plurality of users, and a processor in communication with the interface. The processor may be configured to assign a first plurality of items selected from an item inventory stored in a computer-readable memory to a plurality of users, wherein each user is assigned at least one item from the first plurality of items, and store item assignment data in the computer-readable memory, the item assignment data identifying which items of the first plurality of items are assigned to each of the plurality of users. The processor may also be configured to provide the interface to a first user of the plurality of users to trade a first item of the first plurality of items assigned to the first user with a second item of the first plurality of items assigned to a second user of the plurality of users and update the item assignment data, stored in the computer-readable memory, to reassign the first item and the second item based on the trade between the first user and the second user. The processor may be further configured to send a distribution request to distribute the plurality of items to the users to whom the first plurality of items are assigned as designated by the item assignment data.

In another embodiment of the system, the distribution request to distribute the first plurality of items is sent after the close of a designated trading period.

In a further embodiment of the system, the at least one item assigned to the first user may be designated by the first user to not be distributed to the first user, and instead be carried over to a next trading period.

In yet another embodiment of the system, the processor may be further configured to assign a second plurality of items selected from the item inventory to a first group of purchasable items, the first group of purchasable items having a discounted purchase price based on the total price of the first group of purchasable items and assign the first group of purchasable items to the first user based on a request by the first user to purchase the first group of purchasable items. The processor may also be configured to send a distribution request to distribute the items of the first group of purchasable items to the first user.

In yet a further embodiment of the system, the items of the first group of purchasable items may be distributed to the first user after the close of a designated trading period, a length of the designated trading period being based on the discounted purchase price of the first group of purchasable items.

In another embodiment of the system, the trade between the first user and the second user may be based on an identification of the second item by the first user as an item the first user is willing to trade for the first item.

In a further embodiment of the system, the trade between the first user and the second user may be based on an identification by the first user that the second user is a user the first user would like to trade with.

In yet another embodiment of the system, the first user may receive a plurality of trade offers for the first item, and the processor may be further configured to transfer the plurality of trade offers for the first item from the first user to the second user based on the trade between the first user and the second user of the first item for the second item.

In yet a further embodiment of the system, the processor may be further configured to receive a counter-offer from the second user to the first user based on the trade between the first user and the second user, wherein the counter-offer comprises an additional item for the first user to provide in order to complete the trade between the first user and the second user, and receive an acknowledgement from the first user to complete the trade with the second user based on the counter-offer from the second user.

In another embodiment of the system, the additional item may include a virtual currency amount, the virtual currency being redeemable by the second user.

In a further embodiment of the system, the processor may be further configured to assign a predetermined number of trades to the first user, wherein the predetermined number of trades is based on an initial purchase amount received from the first user, increase the number of trades assigned to the first user based on a second purchase amount received from the first user, and decrease the number of trades assigned to the first user based on the trade of the first item for the second item.

In yet another embodiment of the system, the processor may be further configured to receive a purchase amount from the first user to display a trade request with a predetermined feature for the second item, and display the trade request with the predetermined feature to the second user.

In yet a further embodiment of the system, the predetermined feature may include displaying the trade request at a specified location on a display of the second user.

### BRIEF DESCRIPTION OF THE DRAWINGS

FIG. 1 illustrates an example of a merchandise trading system in accordance with aspects of the disclosure.

FIG. 2A illustrates an example of an inventory being assigned to a plurality of customers in accordance with aspects of the disclosure.

FIG. 2B illustrates another example of an inventory being assigned to a plurality of customers in accordance with aspects of the disclosure.

FIG. 3A illustrates an example of a trade operation performed between two customers in accordance with aspects of the disclosure.

FIG. 3B illustrates another example of a trade operation performed between two customers in accordance with aspects of the disclosure.

FIG. 4 is a screen capture of an exemplary interface for interacting with the system of FIG. 1 in accordance with aspects of the disclosure.

FIG. 5 is a screen capture of an exemplary interface for selecting an item to create a trade offer in accordance with aspects of the disclosure.

FIG. 6 is a screen capture of an exemplary interface for selecting items to include in a trade offer in accordance with aspects of the disclosure.

FIG. 7 is a screen capture of an exemplary interface for confirming a trade offer in accordance with aspects of the disclosure.

FIG. 8 is a screen capture of an exemplary interface for accepting a trade offer in accordance with aspects of the disclosure.

FIG. 9 illustrates an example of logic flow for trading merchandise in accordance with aspects of the disclosure.

FIG. 10 illustrates an example of logic flow for participating in a merchandise trading operation in accordance with aspects of the disclosure.

### DETAILED DESCRIPTION

The aspects, features and advantages of the present disclosure will be appreciated when considered with reference to the following description of preferred embodiments and accompanying figures. The following description does not limit the disclosure; rather, the scope is defined by the appended claims and equivalents.

While certain processes in accordance with example embodiments are shown in the figures as occurring in a linear fashion, this is not a requirement unless expressly stated herein. Different processes may be performed in a different order or concurrently.

The disclosure describes systems and methods for merchandise trading among one or more customers of a commerce site. Customers of the site are assigned one or more items from an item inventory. The customers may trade these items among themselves to acquire desired items that may not be included in their original assigned items. At the end of a trading period, one or more of the items assigned to the customers may be physically delivered to the customers to whom they are assigned. Customers may designate particular items to carry over to the next trading session, during which the designated items will then be available for trade. Customers may also be randomly assigned a bonus item from a different item set from the item inventory. These bonus items may be more desirable for various reasons, such as a higher MSRP, increased rarity, being part of a new release, fashion season or model year, or any other reason for increased desirability. Customers may subscribe to the commerce site, and receive a new set of items for each trading period.

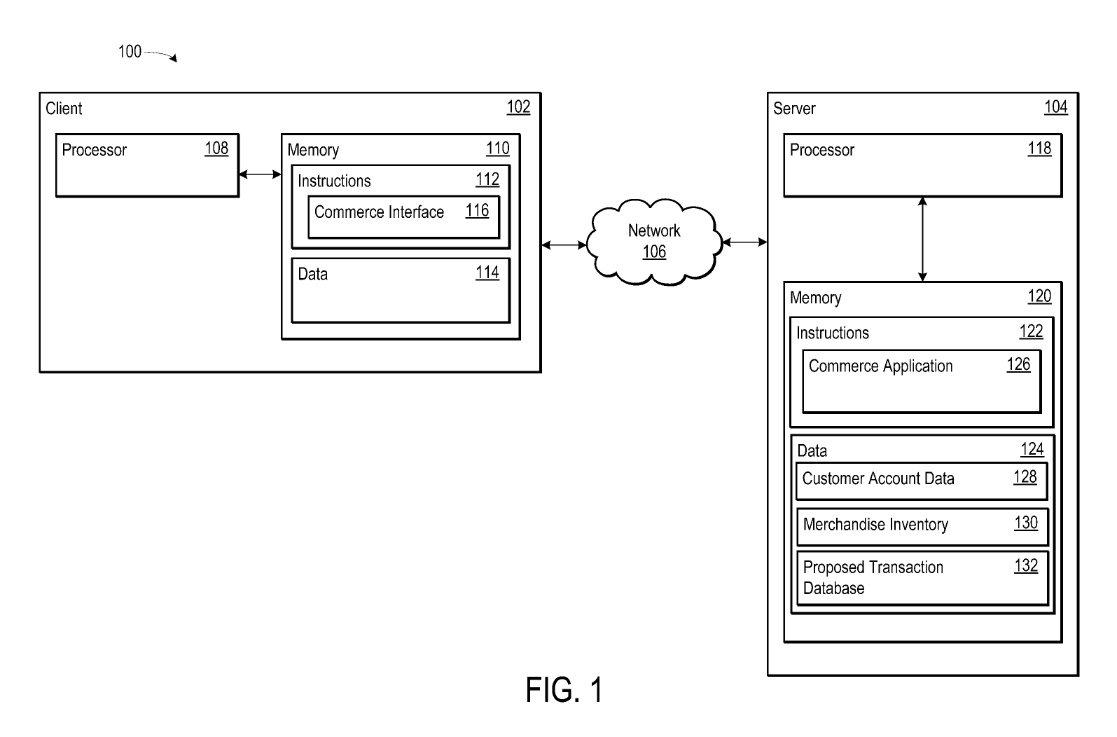

FIG. 1 illustrates an example of a merchandise trading system 100 in accordance with aspects of the disclosure. FIG. 1 presents a schematic diagram of a system depicting various computing devices that may be used alone or in a networked configuration in accordance with aspects of the disclosure. For example, the merchandise trading system 100 may include a client 102 in communication with a server 104 via a network 106. A user may use the client 102 to interface with a commerce application 126 hosted on the server 104. For example, the client 102 may include a commerce interface 116, such as provided by a web page displayed in a web browser.

The client 102 may be any type of client, such as a desktop computer, a laptop computer, a netbook, a tablet, a mobile device (e.g., cellular phone, smartphone, personal digital assistant, etc.). In one embodiment, the commerce application 126 may be configured to recognize a mobile device and provide a customized experience to the user based on this recognition. For example, the commerce application 126 hosted on the server 104 may be displayed in one configuration where the client 102 is a desktop computer, but the commerce application 126 may be displayed in a different configuration where the client 102 is a mobile device. In this regard, there may be different features shown in the configurations of the commerce application 126, depending on the type of client 102 accessing the commerce application 126 (e.g., the mobile configuration of the commerce application 126 may have different features than the desktop configuration of the commerce application 126, and vice versa).

The client 102 may include a processor 108, a memory 110 and other components typically present in general purpose computers. The memory 110 may store instructions 112 and data 114 that are accessible by the processor 108. The processor 108 may execute the instructions 112 and access the data 114 to control the operations of the client 102.

The processor 108 may be any suitable processor, such as various commercially available general purpose processors. Alternatively, the processor 108 may be a dedicated controller such as an application-specific integrated circuit (“ASIC”) or a field-programmable gate array (“FPGA”).

The memory 110 may be any type of computer-readable memory operative to store information accessible by the processor 108, including a computer-readable medium, or other medium that stores data that may be read with the aid of an electronic device, such as a hard-drive, memory card, read-only memory (“ROM”), random access memory (“RAM”), digital versatile disc (“DVD”) or other optical disks, as well as other write-capable and read-only memories. The system and method may include different combinations of the foregoing, whereby different portions of the instructions and data are stored on different types of media.

Although FIG. 1 functionally illustrates the processor 108 and memory 110 as each being within a single block, it should be understood that the processor 108 and memory 110 may actually comprise multiple processors and memories that may or may not be stored within the same physical housing. Accordingly, references to a processor, computer or memory will be understood to include references to a collection of processors, computers or memories that may or may not operate in parallel.

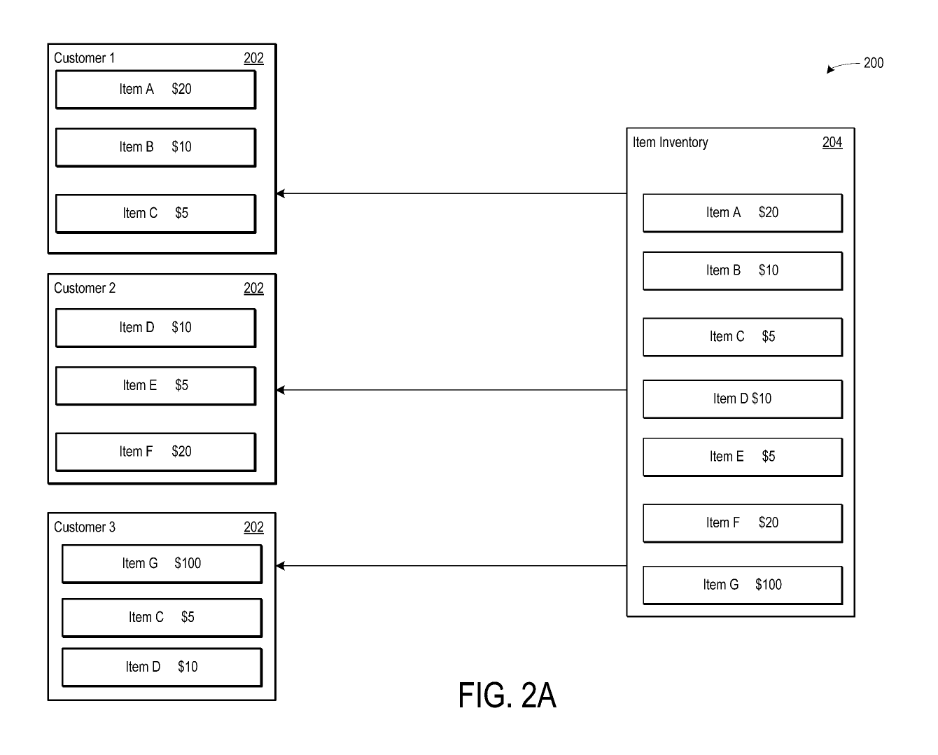

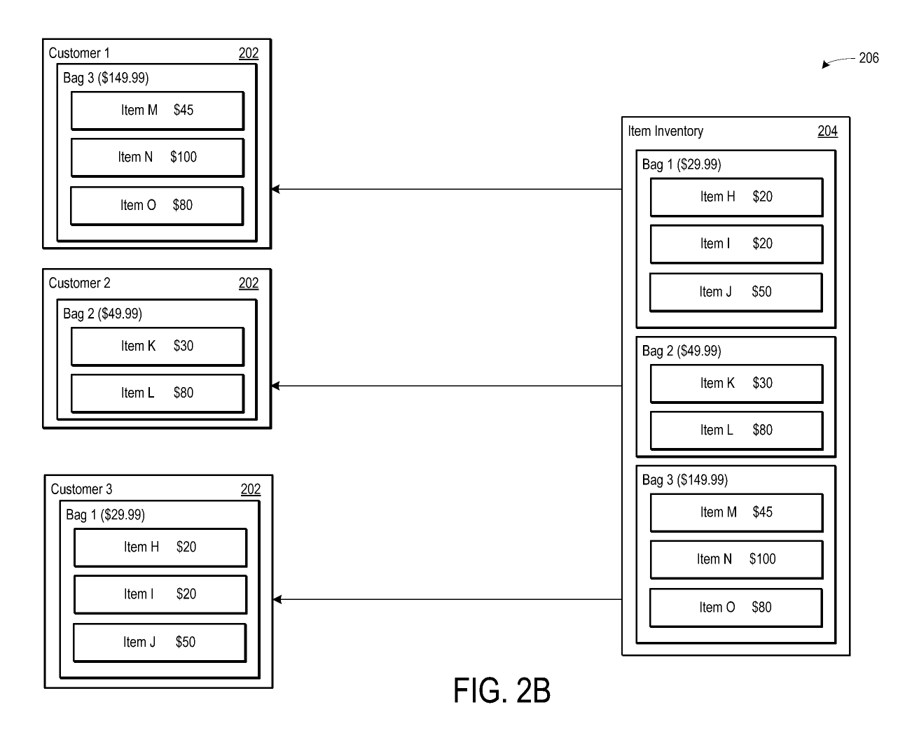

The instructions 112 may be any set of instructions to be executed directly (such as machine code) or indirectly (such as scripts) by the processor 108. For example, the instructions 112 may be stored as computer code on a non-transitory computer-readable medium. In that regard, the terms “instructions” and “programs” may be used interchangeably herein. The instructions 112 may be stored in object code format for direct processing by the processor 108, or in any other computer language including scripts or collections of independent source code modules that are interpreted on demand or compiled in advance. Functions, methods and routines of the instructions are explained in more detail below (see FIGS. 2A-10).

In order to facilitate the operations of the computing device 102, the instructions 112 may comprise a commerce interface 116, such as, for example, a web browser displaying a web site received from the server 104. A user may interact with the commerce interface 116 to perform actions with the merchandise trading system, such as viewing merchandise, receiving a list of assigned items, proposing trades with other users, executing trades with other users, etc. The commerce interface 116 may perform these and other actions by sending messages, control signals, data, and the like, to the server 104. Example illustrations of a commerce interface are provided below.

Data 114 may be retrieved, stored or modified by the processor 108 in accordance with the instructions. For instance, although the merchandise trading system 100 is not limited by any particular data structure, the data may be stored in computer registers, in a relational database as a table having a plurality of different fields and records, Extensible Markup Language (“XML”) documents or flat files. The data may also be formatted in any computer readable format such as, but not limited to, binary values or Unicode. The data may comprise any information sufficient to identify the relevant information, such as numbers, descriptive text, proprietary codes, references to data stored in other areas of the same memory or different memories (including other network locations) or information that is used by a function to calculate the relevant data.

The server 104 may function to manage user information, track an inventory of merchandise, and facilitate transactions among users. The server 104 may provide these and other functions via a commerce application 126. In addition to inventory management and merchandise trading functions, the commerce application 126 may provide various other features to enhance the user experience, including but not limited to, allowing users to purchase particular items, allowing users to take a “style quiz” to identify particular items in which they might be interested, hosting of advertisements to be displayed to users, tracking of site analytics and metrics, providing one or more news feeds relevant to the merchandise offered via the merchandise trading system, providing social networking functionality, or any other feature that may enhance the user experience.

The server 104 may be configured similarly to the client 102, with a processor 118 in communication with a memory 120. The memory 120 may comprise a set of instructions 122 and data 124 to facilitate the operations of the server 104. The instructions 122 may include the commerce application 126 as described above. The data 124 may include customer account data 128, a merchandise inventory 130, and a proposed transaction database 132. The customer account data 128 may include user details, such as login credentials, shipping addresses, merchandise preferences, account status, or any other information associated with a particular user or group of users. The merchandise inventory 130 may include information describing items currently provided, previously provided, or that will be provided via the merchandise trading system. The merchandise inventory 130 may include cross-references to the customer account data 128 to identify which items are currently assigned to which customers for the purpose of executing trades among the customers. Trade information may be stored in the proposed transaction database 132. For example, the proposed transaction database 132 may include a list of which customers are interested in trading particular items for other particular items. Methods by which the items may be assigned to customers and traded with other customers are described further below (See FIGS. 2A-10).

The client 102 and the server 104 may each be at separate nodes of a network and be operative to directly and indirectly communicate with other nodes of the network 106. For example, the client 102 may comprise a network client that is operative to communicate with the server 104 via the network 110.

The network 106, and the intervening nodes between the computing device 102 and the transaction network operator 104 may comprise various configurations and use various protocols including the Internet, World Wide Web, intranets, virtual private networks, local Ethernet networks, private networks using communication protocols proprietary to one or more companies, cellular and wireless networks (e.g., Wi-Fi), instant messaging, hypertext transfer protocol (“HTTP”) and simple mail transfer protocol (“SMTP”), and various combinations of the foregoing. It should be appreciated that a typical system may include a large number of connected computers.

Although certain advantages are obtained when information is transmitted or received as noted above, other aspects of the system and method are not limited to any particular manner of transmission of information. For example, in some aspects, information may be sent via a medium such as an optical disk or portable drive. In other aspects, the information may be transmitted in a non-electronic format and manually entered into the system.

FIG. 2A illustrates an example of an inventory assigned to a plurality of customers in accordance with aspects of the disclosure. FIG. 2A illustrates an exemplary item inventory 204 containing seven item designations, Items A-G. Each of items A-G may be assigned a particular Manufacturer Suggested Retail Price (MSRP), shown in the figure by a dollar sign amount. When customers register with the merchandise trading system, they may receive a random selection of items from the item inventory. The items assigned to the particular customer may have a minimum and/or maximum aggregate MSRP value.

For example, FIG. 2A depicts three customers 202 that have each been assigned a set of items from the item inventory. Although in the present example, each customer has been assigned three items, a customer may be assigned more or fewer items depending upon how the merchandise assignment process is configured. For example, merchandise may be assigned solely on a MSRP basis, such that a first customer may receive multiple, less valuable, items, while a second customer receives a single more valuable item with the same MSRP as the total MSRP of all of the first customer's items. In the present example, each of Customer 1 and Customer 2 has received three different items with a sum total MSRP of $35.

In addition, the merchandise trading system 100 may facilitate the purchase of additional items for a set fee. Thus, a customer may initially be assigned one or more items from the item inventory 204, but then the merchandise trading system 100 may offer the customer a chance to purchase an additional item, where the cost of the additional item may be based on the additional item's MSRP. Further still, the merchandise trading system 100 may alter the purchase price of the additional item, such as where the additional item is purchased frequently, traded frequently, displayed frequently, and so forth.

In this manner, popular items (e.g., items that are purchased, displayed, traded, selected, etc., more frequently than other items) may have an increased purchased price or a price that increases over time, whereas less popular items (e.g., items that are purchased, displayed, traded, selected, etc., less frequently than other items) may have a reduced price or a price that decreases over time. Other criterions that may factor into the purchase price of the additional items offered to the customer may also include the name brand associated with the item, the category (e.g., clothing, housewares, kitchen accessory, etc.) associated with the item, the MSRP of the item, and other such criterion.

In an alternative implementation, customers may purchase a grouping of items (i.e., a “bag of items”) known to have a suggested MSRP. FIG. 2B illustrates an example of customers being able to buy one or more bags of items stored in the item inventory 204. In one embodiment, the server 104 may randomly assigned the items to a bag at the time of purchase, but in another embodiment, the server 104 may have assigned the items to the bags prior to purchase. Thus, there may be times when the contents of a bag are randomly assigned, but other times when the contents of a bag are predetermined.

The MSRP of items assigned to a bag may or may not exceed the price point of the bag itself. In the example shown in FIG. 2B, the items of a first bag (i.e., “Bag 1”) may have a suggested MSRP of $90.00, but the bag itself is offered at a price point of $29.99, the items of a second bag (i.e., “Bag 2”) may have a suggested MSRP of $110.00, but the bag itself is offered at a price point of $49.99, and the items of a third bag (i.e., “Bag 3”) may have a suggested MSRP of $225.00, but the bag itself is offered at a price point of $149.99. In an alternative implementation, there may be instances where the cost of the bag exceeds the suggested MSRP of the items assigned to the bag.

The items of Bags 1-3 may or may not be known to the one or more customers (e.g., Customers 1-3) purchasing the bags. For example, the server 104 may inform the customers of the number of items in a bag, but may not display the contents of that bag (e.g., that Bag 1 contains three items, but none of the items are revealed to the customer until after purchase). Alternatively, or in addition, the server 104 may display an item from a bag, such as Item H assigned to Bag 1, as an enticement to the customer to purchase Bag 1. Combinations of the foregoing are also possible.

Referring back to FIG. 2A, the system may also assign “bonus” items to customers. These bonus items may be assigned along with or in lieu of other items. These bonus items may be more desirable than non-bonus items for a variety of reasons. For example, the bonus items may be a new-release item from an upcoming fashion season, the bonus items may have a higher MSRP than other items, or the bonus items may be rarer than the other items. In the example of FIG. 2A, Customer 3 has received a bonus item, “Item G” that has a much higher MSRP than Items A-F. The bonus items may be assigned in a variety of manners, such as by pure random chance during the assignment process, or by some other weighted metric, such as by increasing the likelihood of receiving a bonus item the longer the customer has been a subscriber.

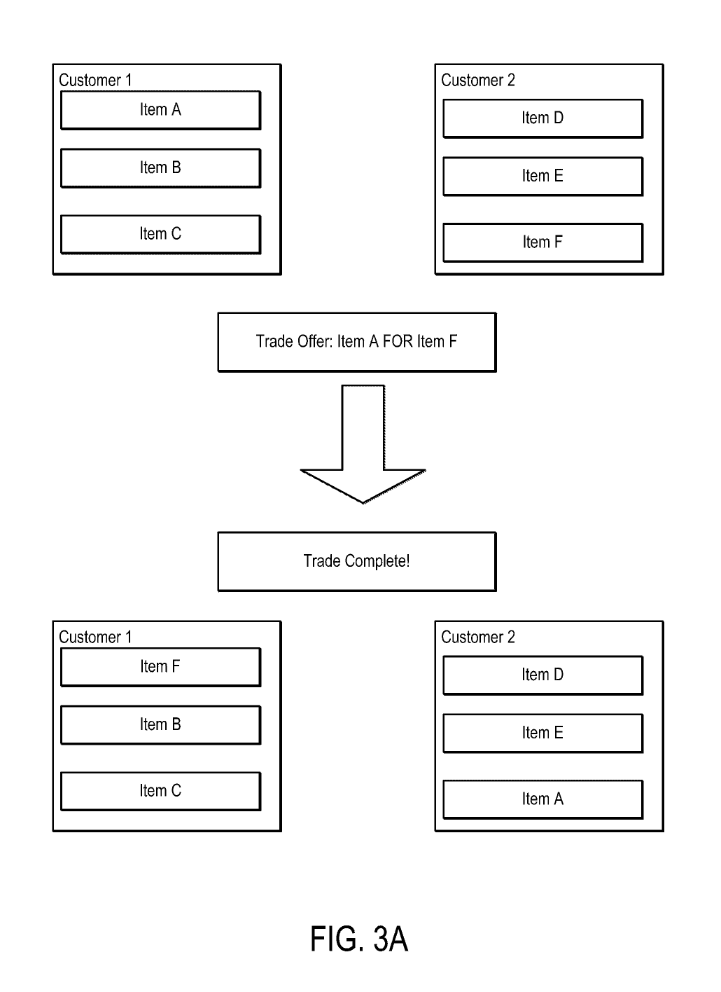

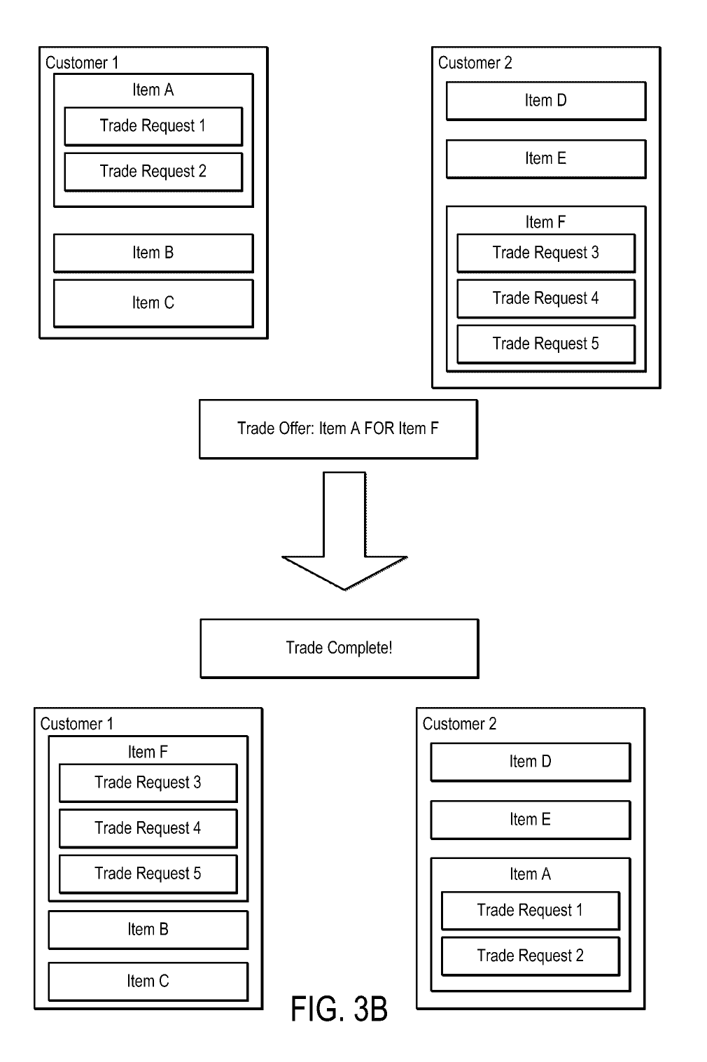

The merchandise trading system 100 may also facilitate trades between customers. FIG. 3A illustrates an example of a trade operation performed between two customers in accordance with aspects of the disclosure. In the example, Customer 1 and Customer 2 wish to trade an item. The trade may be initiated in a variety of manners, such as one of the customers placing a “trade request” with the merchandise trading system. The customer may indicate that he or she has a first item (e.g., Item A) and wishes to trade for a second item (e.g., Item F).

In one embodiment, the merchandise trading system 100 may initially assign a predetermined number of trades to a customer based on an initial cost. For example, the merchandise trading system 100 may initially assign 10 trades to a customer based on an initial purchase with the merchandise trading system 100. Moreover, the merchandise trading system 100 may establish an exchange rate of trades, such that a predetermined amount spent by a customer results in an additional number of trades to the customer. As examples, a customer may spend $10.00 to receive an additional two trades, $20.00 to receive an additional four trades, and so forth.

In one embodiment, when the customer places the trade request, the request may be visible to all customers that are currently assigned the desired item (Item F, in the present example). This first embodiment may be considered a “product-to-product” trade, in which the merchandise trading system 100 seeks out or identifies other customers that have the item desired by the requesting customer. In another embodiment, the customer may request to trade for an item held by another, specific customer. This other embodiment may be considered a “peer-to-peer” trade, in which the requesting customer may identify a specific customer, such as a friend, a person from a contact list, or other customer, for trading items. Moreover, the merchandise trading system 100 may facilitate trades of both the “product-to-product” trade type and the “peer-to-peer” trade type.

In making trade requests, the merchandise trading system 100 may offer a customer the chance to purchase “preferred” trade requests or to convert a “normal” trade request to a “preferred” trade request. In one embodiment, the merchandise trading system 100 may establish a number of features for a “preferred” trade request. For example, a preferred trade request for one customer may appear at a specific location on other customers' trade lists, such as the top of the trade list, or the preferred trade request may be embellished with attention-grabbing decorations, such as a larger font size, background coloring, or other such decorations. Thus, a trade request that is a preferred trade request may receive additional attention from a customer than a normal (i.e., not preferred) trade request would.

Although FIG. 3A illustrates a single item trade, the merchandise trading system may support multiple item trades, such as trading two items for two other items or trading a single item for multiple items. The system may also allow gifting of items to other customers, where a customer may reassign an item to another customer without receiving an item in return.

Once a second customer that has the desired item accepts the trade, the merchandise trading system may reassign the items such that the customers trade items. Furthermore, prior to the completion of the trade, the merchandise trading system may display a message or prompt to one or more customers engaged in the trade that requests confirmation that the customer desires to complete the trade (e.g., the message or prompt may display a question such as “Are you sure you would like to complete this trade?”). The confirmation message or prompt may be displayed to the customer initiating the trade request, the customer accepting the trade request, or both customers involved in the trade. In this regard, the merchandise trading system 100 provides an accidental trading reduction mechanism which focuses on preventing trades from occurring should a customer accidentally initiate or accept a trade.

Customers may continue to initiate trades until an end of the trading period. Trading periods may last for a particular period of time, such as an hour, a day, a week, or a month. Trading periods may also be defined in other manners, such as by ending the trading period once a particular number of trades have occurred, or a particular number of customers have elected to receive shipment of their assigned items. Trading periods may also be associated with an individual customer, allowing customers to end their personal trading period and receive their items at any time. A new trading period may begin immediately upon the end of the previous one, or trading periods may begin at particular designated times.

Moreover, the length of a trading period may be based on an amount spent by a customer. For example, referring to FIG. 2B, the length of the trading period for Customer 1, who purchased Bag 3, may be longer than the length of the trading period for Customer 3, who purchased Bag 1. In one embodiment, the length of a trading period may be associated with the purchase of a given item (e.g., the trading period of Bag 3 may be five days, whereas the trading period for Bag 1 may be two days). Alternatively, or in addition, the length of a trading period is incrementally extended as a customer spends a predetermined amount. For example, every customer may receive an initial two days in his or her trading period, and for each dollar spent by the customer, that customer extends his or trading period by two hours. In this regard, and still referring to FIG. 2B, Customer 2 may be assigned an initial 2-day trading period, which is then extended by 100 hours, which is approximately $49.99 multiplied by two. Thus, while the merchandise trading system 100 may define a trading period in any manner, a trading period may be defined based on the amount spent by the customer.

In some circumstances, customers may engage in a trade where the traded items are of different values, or where a customer requests additional compensation for a traded item. For example, referring to FIG. 3A, Item F may have a higher value (e.g., $50.00) than Item A (e.g., $25.00). In this circumstance, Customer 2 may request or require that Customer 1 provide additional compensation to engage in the trade. In one embodiment, the merchandise trading system 100 may query Customer 1 whether Customer 1 wishes to purchase a virtual currency to make up the difference in value between Item F and Item A. For example, the merchandise trading system 100 may query whether Customer 1 desires to purchase an amount of virtual currency that corresponds to the difference in value between Item F and Item A.

The virtual currency purchasable by Customer 1 may be represented by any number or types of identifiers, such as points, credits, coins, or any other such identifiers. Furthermore, the merchandise trading system 100 may maintain an exchange rate between the virtual currency and one or more real-world currencies (e.g., U.S. dollars, English pounds, Euros, rupees). In purchasing the virtual currency from the merchandise trading system 100, Customer 1 may provide a credit card number, debit card number, bank account number, PayPal™ account number, or any other account number from which to deduct the cost of the purchasable virtual currency. Furthermore, in purchasing virtual currency, the merchandise trading system 100 may offer deals or incentives to the purchasing customer. As one example, the merchandise trading system 100 may offer discounted prices on the virtual currency as the amount of virtual currency purchased by the customer is increased (i.e., bulk purchases). In this regard, there may be various thresholds of the amount of purchased virtual currency that further decrease the cost of the purchase virtual currency (e.g., 50 virtual currency costs $50.00 USD, 100 virtual currency costs $95.00 USD, 150 virtual currency costs $135.00 USD, etc.).

When purchased, the virtual currency may then be credited to the customer's account such that the customer may use the purchased virtual currency in pending or future trades. Referring to FIG. 3A, should Customer 1 use an amount of virtual currency in the trade with Customer 2, the amount of virtual currency used by Customer 1 may then be credited to the account of Customer 2. Customer 2 may then redeem the virtual currency based on the exchange rate maintained by the merchandise trading system 100.

In trading between customers, one or more customers may send messages that accompany a trade request. For example, referring to FIG. 3A, Customer 1 may include a message to Customer 2 when requesting a trade of Item A for Item F. The message sent to Customer 2 may be a personal message that Customer 1 has provided to the merchandise trading system 100. Alternatively, the message may be a message that Customer 1 selects from a menu of messages. Moreover, the message may be an alphanumeric message (e.g., a message consisting of text-based characters), an audio message (e.g., an audio recording of Customer 1 speaking), an audio-visual message (e.g., a video recording of Customer 1 speaking), or combinations of the foregoing. For example, the message sent to Customer 2 may include a text message and/or an audio message from Customer 1.

FIG. 3B illustrates another example of a trade operation performed between two customers in accordance with aspects of the disclosure. In FIG. 3B, Customer 1 may have requested a trade with Customer 2 of Item A for Item F. Moreover, Customer 1 and/or Customer 2 may have received trade requests for Items A and F, respectively, from other customers (e.g., a Customer 3, a Customer 4, etc.). As shown in FIG. 3B, Customer 1 may have received two other trade requests for Item A, designated as Trade Request 1 and Trade Request 2, and Customer 2 may have received three other trade requests for Item F, designated as Trade Request 3, Trade Request 4, and Trade Request 5.

When Customer 1 and Customer 2 engage in the trade of Item A and Item F, the trade requests associated with each of Item A and Item F may carry over to the customer that engaged in the trade. In other words, when Item A and Item F are traded between Customer 1 and Customer 2, Customer 1 may have the option of engaging in Trade Requests 3-5 associated with Item F, and Customer 2 may have the option of engaging in Trade Requests 1-2 associated with Item A. Furthermore, when a customer engages with a transferred trade request, the customer may have complete access to the trade request (e.g., canceling the request, modifying the request, presenting a counter-offer, etc.) as if the receiving customer of the transferred trade request was the initial customer associated with the transferred trade request. In this regard, the disclosed merchandise trading system 100 ensures that customers who engage in trades with desirable items do not lose the trade opportunities associated with those items.

While FIGS. 3A and 3B illustrate two customers engaging in a trade, there may be times when a customer has item that he or she no longer wants or desires, and is not interested in pursuing trades for other items. In this regard, the customer may interact with the merchandise trading system 100 to post an advertisement or message indicating that he or she is willing to trade the item that he or she no longer wants or desires. In one embodiment, the server 104 may maintain a database (not shown) or other repository of these advertisements or messages, which may be accessible or viewable by other customers of the merchandise trading system 100.

When a second or third customer selects the advertisement or message, and indicates a willingness to trade for the item associated with the advertisement or message (e.g., by selecting a graphical button or the like), the second customer may be invited to provide the terms of the proposed trade with the first customer (e.g., to indicate what the second customer is willing to trade with the first customer for the item no longer wanted or desired by the first customer). Thus, the merchandise trading system 100 may provide a mechanism by which customers may post advertisements or messages for items they no longer want or desire, and would rather solicit trades for those items rather than pursue trades for those items.

While the foregoing examples (i.e., FIGS. 2A-3B) have been discussed with regard to “live” or “real-world” purchasing and trading, the merchandise trading system 100 may also establish a virtual environment in which one or more customers may participate. In this regard, the virtual environment may have the same, or nearly the same, experiences and opportunities as the real or live environment, such that the customer may simulate the experience of live trading or live purchasing of items. In the virtual environment, a customer may engage in virtual purchases of virtual items, virtual trades with virtual customers, and participate in other such virtual activities. To implement these features, and in one embodiment, the server 104 may store a virtual environment application or program, and the virtual environment application or program may be programmed with, or draw from, data based on the real-world data of items and/or customers stored in the server 104. Accordingly, when a customer engages with the merchandise trading system 100, the customer may have the opportunity to practice with the virtual environment, before deciding to participate in the real-world version.

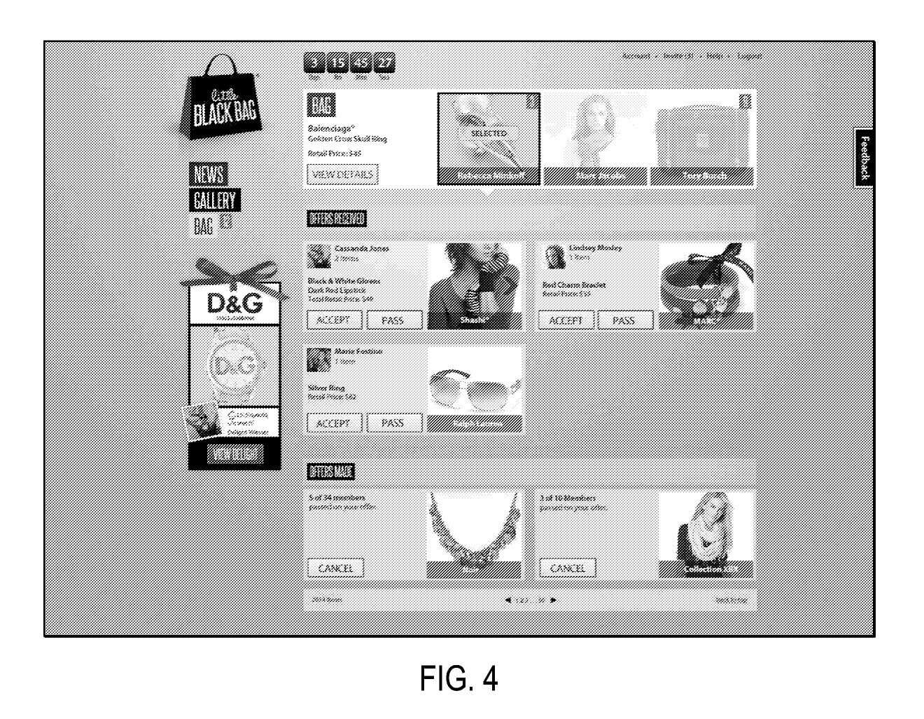

Referring next to FIG. 4 is a screen capture of an example interface for interacting with the system in accordance with aspects of the disclosure. The example interface shows a listing of assigned items in the user's “bag” (e.g., items that are assigned to the user and available to trade), a listing of item offers the user has received for items in their bag, and a listing of trade offers made by the user. Interface options may also allow the user to browse the listing of inventory items to see all items that are available for the current trading period. Items that are displayed may be associated with items that are currently assigned to the user and other customers such that the user can select the items to receive product information and/or propose trades. The interface may also display a countdown to the end of the current trading period, as shown in the upper left hand area of the illustration. The user may navigate among different categories of items. In the example interface, the user is viewing items contained within the category of “charms.” However, the merchandise trading system may include multiple categories of items. The merchandise trading system may also provide a variety of search and display options, allowing for the user to find and select available items in different ways.

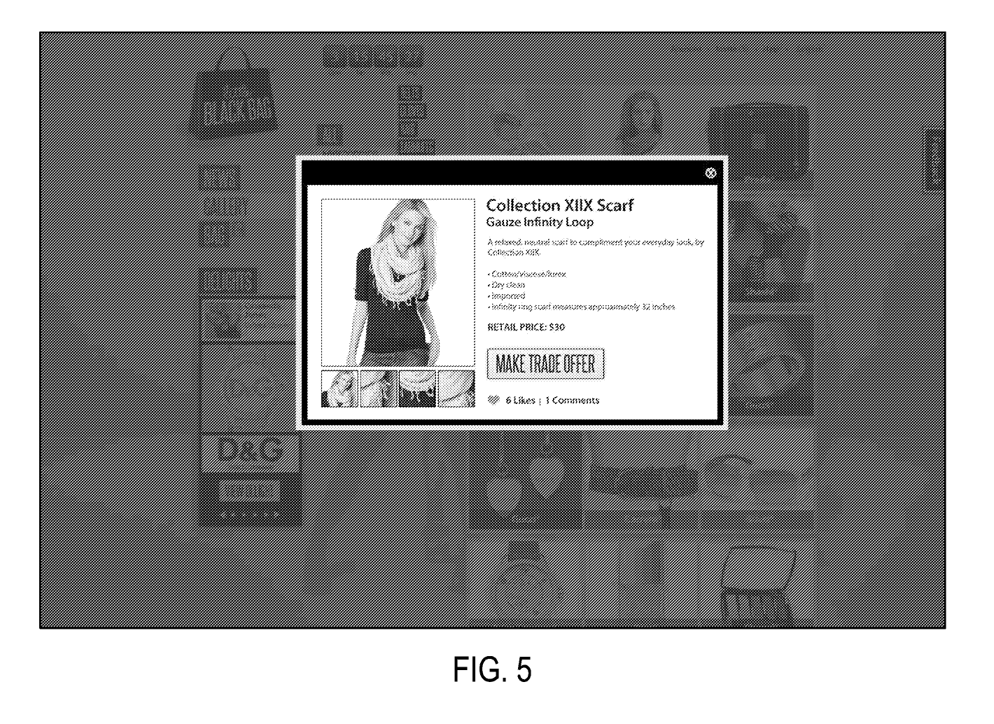

FIG. 5 is a screen capture of an example interface for selecting an item to create a trade offer in accordance with aspects of the disclosure. The illustration depicts a detailed view of a particular item, in this case, a scarf. The user may be presented with a list of information about the item, including one or more images, textual information about the item, the item's MSRP, and comments posted by other users about the item. The interface may include a button by which the user may create a trade offer for the item.

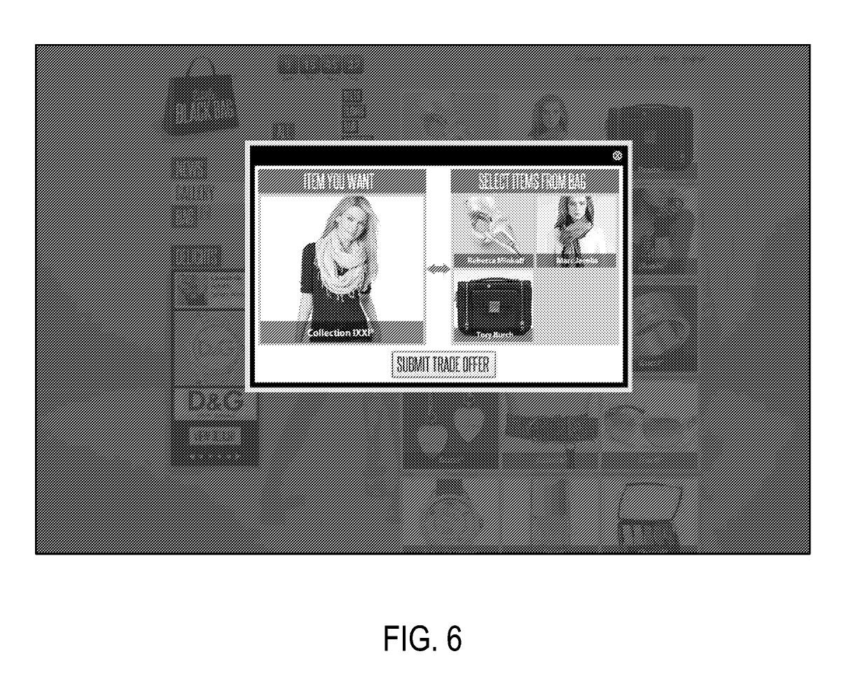

FIG. 6 is a screen capture of an example interface for selecting items to include in a trade offer in accordance with aspects of the disclosure. In the example interface, the customer has selected an item for which they wish to trade, such as the scarf described with respect to FIG. 5. The illustrated trade interface displays the desired item along with a list of items the customer has available for trade. For example, the trade interface may display all of the items that are currently assigned to the customer. The customer may select the item or items they wish to offer in exchange for the desired item. Once the customer has selected the items they wish to trade for the desired item, they may confirm and create the trade offer by selecting the “submit trade offer” interface control.

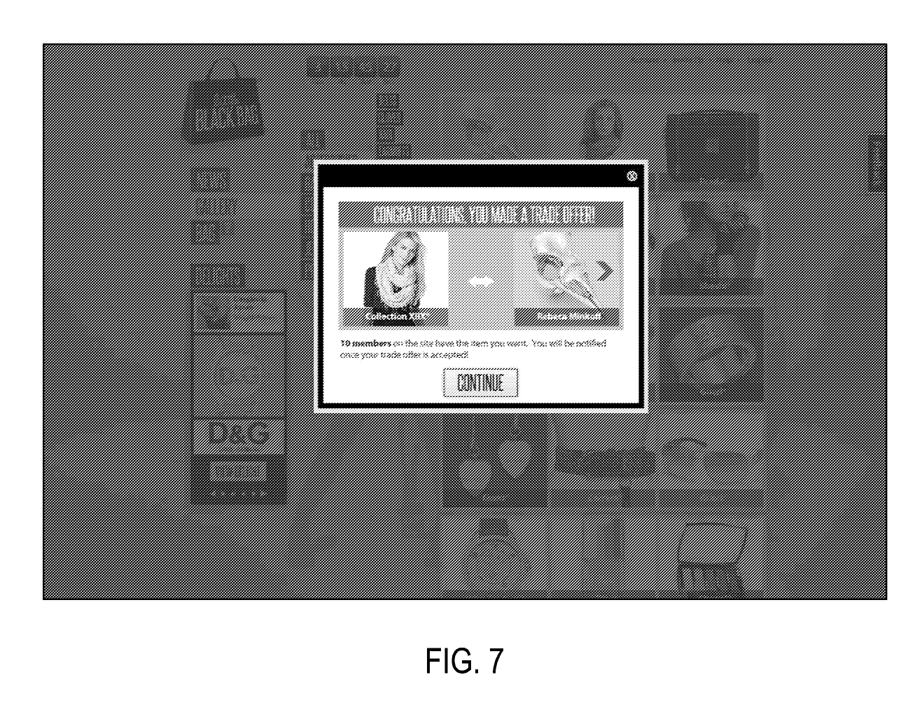

FIG. 7 is a screen capture of an example interface for confirming a trade offer in accordance with aspects of the disclosure. The illustrated interface shows a confirmation dialogue verifying the desired item along with the offered item. The interface may also display information about the trade, such as the number of other users on the site that have the desired item.

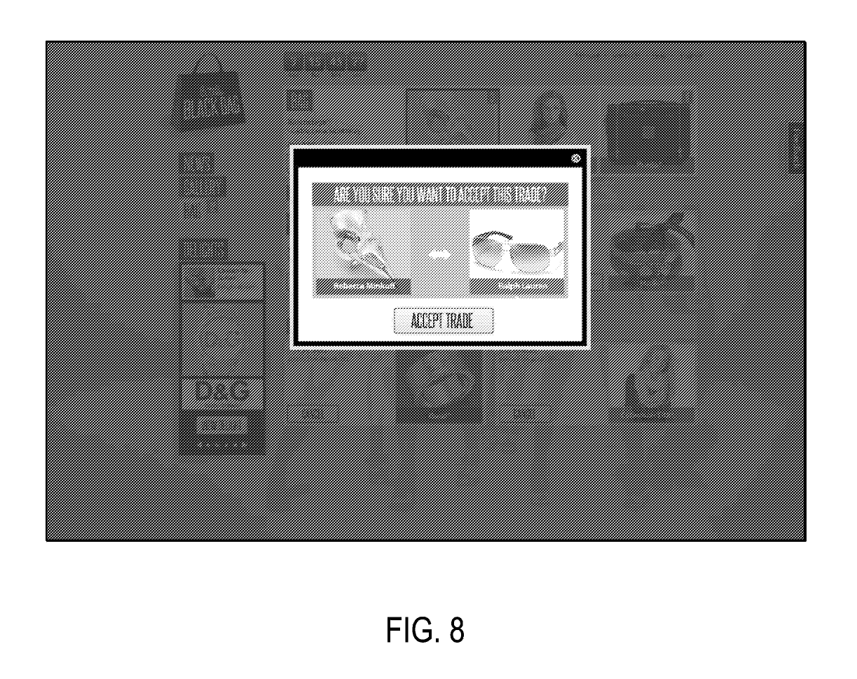

FIG. 8 is a screen capture of an example interface for accepting a trade offer in accordance with aspects of the disclosure. The user may be provided with an interface showing outstanding trade offers corresponding to the items that are currently assigned to the user. Upon selecting one of these trade offers, the user may be presented with a detailed view of the proposed trade. The interface may allow the user to receive additional information about each item involved in the trade, such as by performing a selection operation on an interface control corresponding to the item in question or moving the mouse cursor over the interface control item. If the user approves of the trade, he or she may accept the trade by selecting the “accept trade” interface control. Once the trade is accepted, the items may be reassigned to the users involved in the trade.

Alternatively, or in addition, the user may present a counter-offer to the received trade offer. The counter-offer may include alterations to one or more terms of the initial offer, such as requesting additional items for the offer, substituting items in the offer, removing or changing items of the offer, or any other alterations to the initial offer. In addition, a counter-offer may include substituting one or more items of the offer with items of the same type (e.g., a scarf for another scarf) or items that have different types (e.g., a pair of jeans for an offered scarf).

Although the user may present a counter-offer with different or additional items, the user may also present a counter-offer that includes or substitutes intangible items for the items in the trade offer. Examples of intangible items include virtual currency, points, credits, and other such intangible items. For example, the user may have purchased quantities of a virtual currency, and the user may present various quantities of the virtual currency as items for the counter-offer.

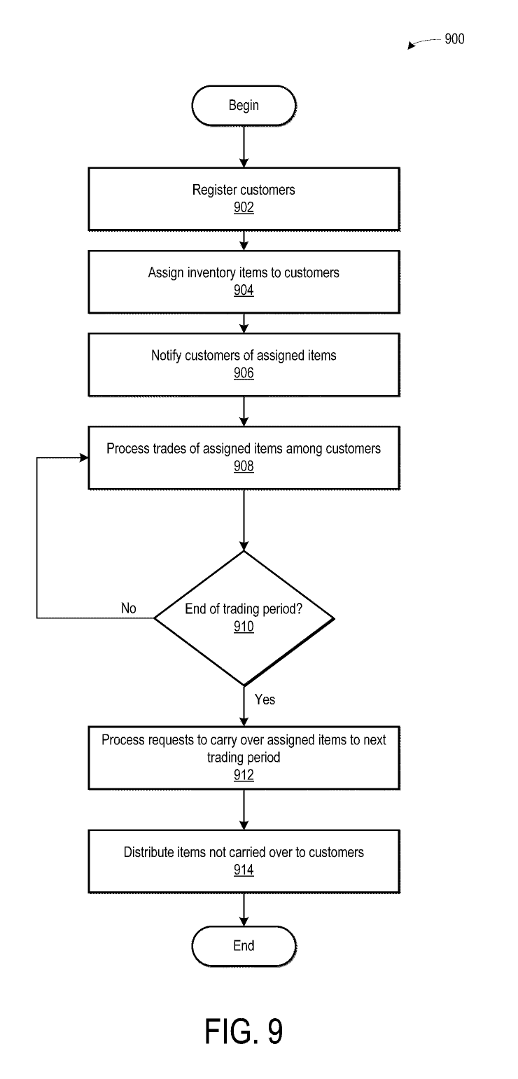

FIG. 9 is a flow diagram depicting an example of a method 900 for trading merchandise in accordance with aspects of the disclosure. As described above, customers may receive a set of assigned items once registering with the merchandise trading system. The method 900 provides for the ability to trade these items with other customers to obtain items that they desire. The method 900 automatically reassigns the traded items to the proper customers as trades occur. Once the trading period ends, items may be carried over to a new trading period or distributed to the customers to whom they are assigned at the end of the trading period.

At stage 902, customers are registered with the merchandise trading system. For example, customers may pay a monthly subscription fee, where each month they receive a new set of items. Alternately, the customers may pay a single fee and receive a single set of items. Customers may be provided with the ability to purchase multiple sets of items by paying an additional fee. In some aspects, customers may not pay a fee directly to the trading system, where the trading system is instead supported by advertisement revenue. The merchandise trading system may also provide a variety of incentives and payment plans, including special sales, promotional items, referral bonuses, and the like.

At stage 904, items are assigned to the registered customers. As described above with respect to FIGS. 1-3, items may be randomly assigned, assigned with value constraints, or via any other method of distributing the items to the customers. Customers may also receive bonus items that are more desirable than other items in the inventory.

At stage 906, customers are notified of their assigned items. This notification may performed in a variety of ways, including sending the user an e-mail or a text message or updating a user's “cart” or “bag” as displayed on a web page associated with the merchandise trading system.

At stage 908, users perform trades of their assigned items with one another, as described above (see FIGS. 1-8). The merchandise trading system processes these trades until a designated end of the trading period. In addition to trading among a general user population, the system may also provide the capability for performing private trades among a particular group of users. For example, a group of users may register together for a private item assignment and trading session among the group. Items may be assigned and traded among the specified group of users without interaction with the rest of the population. Once the private trading session is concluded, these items may be shipped to the user group or assigned for trading among the general customer population.

At stage 910, the system determines if the end of the trading period has been reached. As described above with respect to FIG. 3, the trading period may end in a variety of ways. For example, the trading period may have a definite end time or day, at which point all trading ceases. The trading period may also end when a particular number of trades have occurred, when a particular time limit assigned to each user or a group of users ends, when the user indicates they wish to end their trading period, or any other method of marking the end of the trading period. As described above with respect to stage 908, a private group of users may have a unique trading period timer or other trading period parameters assigned to them. If the trading session is not over, the method returns to stage 908 to continue processing trades. If the trading period is over, the method proceeds to stage 912.

At stage 912, the user may be presented with the opportunity to “carry over” one or more of their assigned items to the next trading session. For example, a user may not wish to receive a particular item they have been assigned, but rather retain the ability to continue trading that item in the next trading session. These requests may be processed at stage 912 to ensure the user retains the ability to trade the item in the next trading period. Items may also be carried over by default, where only items selected by the user for delivery are shipped at the end of the trading period.

At stage 914, items that are not carried over are distributed to the customers to whom they are assigned. These items may be automatically shipped to the users to whom they are assigned using stored shipping preferences associated with the user's account information. For example, the user may enter their shipping address and preferences (e.g., type of shipping option, shipping speed, etc.) when registering their account, such that additional user intervention is not required to receive their items at the end of the trading period.

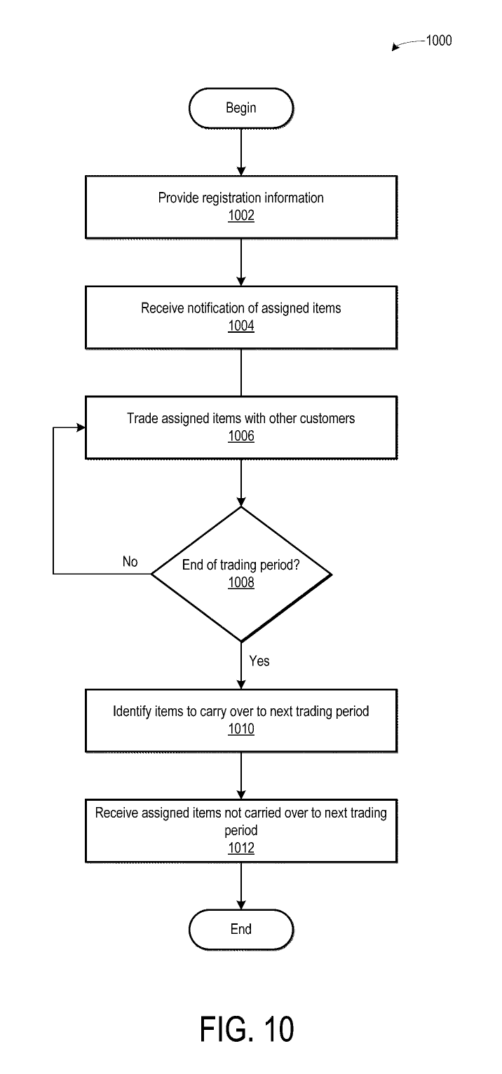

FIG. 10 is a flow diagram depicting an example of a method 1000 for participating in a merchandise trading operation in accordance with aspects of the disclosure. The method 1000 illustrates the process by which a client may interact with the merchandise trading system described with respect to FIGS. 1-9. The client may provide an interface, such as a web page displayed within a browser for performing the method 1000.

At stage 1002, the client provides registration information to register with the merchandise trading system. As described above, the user may provide their account information when registering with the system, such as their name, shipping address, shipping preferences, credit card information for billing, and the like. The merchandise trading system may allow the user to subscribe on a revolving basis, the user may pay a single fee to receive a set of assigned items, or the user may register via any other billing/registration mechanism.

At stage 1004, the client receives a notification of assigned items. For example, when new items are assigned to the particular registered user, the user may receive an e-mail or text message at an address specified in their account details. A web interface may also be automatically updated with information describing the newly assigned items, such as by updating a “cart” or “bag” interface element on a web page associated with the merchandise trading system.

At stage 1006, the client may propose and accept trades with other users, as described above with respect to FIGS. 2-8. These trades may occur until the designated end of the trading period. At stage 1008, trades continue to occur until the end of the trading period. At the end of the trading period, the method 1000 proceeds to stage 1010.

At stage 1010, the user may identify items to carry over to the next trading period. For example, the client may be provided with a summary report describing the trading period and detailing the items that were assigned to the user at the end of the trading period. The client may select one or more of the items to either take delivery of the selected items or carry the selected items over to the next trading period. At stage 1012, the items that the client has elected to receive are shipped by the merchandise trading system and received by the user at the address associated with the user account.

Aspects of the disclosure advantageously provide for a novel merchandise trading system. The merchandise trading system provides an enjoyable way to acquire new merchandise, allowing for users to pursue particular items that they desire. The trading system allows savvy users the opportunity to receive a better “bang for their buck” by performing well-thought-out trades, while allowing more casual users the option to pursue a particular item in which they are interested. Information is organized and clearly presented for all such trades, ensuring that users have all of the relevant information they need before committing to a transaction. As such, the merchandise trading system provides an entertaining method of obtaining new items while also allowing savvy users to save money on brand name merchandise.

As these and other variations and combinations of the features discussed above can be utilized without departing from the disclosure as defined by the claims, the foregoing description of the embodiments should be taken by way of illustration rather than by way of limitation of the disclosure as defined by the claims. It will also be understood that the provision of examples of the disclosure (as well as clauses phrased as “such as,” “e.g.”, “including” and the like) should not be interpreted as limiting the disclosure to the specific examples; rather, the examples are intended to illustrate only some of many possible embodiments.

1. A computer-implemented method for trading merchandise, the method comprising:
assigning, using a processor, a first plurality of items selected from an item inventory to a plurality of users, wherein each user is assigned at least one item from the first plurality of items;
storing item assignment data, the item assignment data identifying which items of the first plurality of items are assigned to each of the plurality of users;
providing, with the processor, an interface that allows a first user of the plurality of users to trade a first item of the first plurality of items assigned to the first user with a second item of the first plurality of items assigned to a second user of the plurality of users;
updating, with the processor, the item assignment data to reassign the first item and the second item based on the trade between the first user and the second user; and
distributing the plurality of items to the users to whom the first plurality of items are assigned as designated by the item assignment data.

2. The method of claim 1, wherein the first plurality of items are distributed after the close of a designated trading period.

3. The method of claim 1, wherein the at least one item assigned to the first user is designated by the first user to not be distributed to the first user, and instead be carried over to a next trading period.

4. The method of claim 1, further comprising:
assigning, with the processor, a second plurality of items selected from the item inventory to a first group of purchasable items, the first group of purchasable items having a discounted purchase price based on the total price of the first group of purchasable items;
assigning, with the processor, the first group of purchasable items to the first user based on a request by the first user to purchase the first group of purchasable items; and
distributing the items of the first group of purchasable items to the first user.

5. The method of claim 4, wherein the items of the first group of purchasable items are distributed to the first user after the close of a designated trading period, a length of the designated trading period being based on the discounted purchase price of the first group of purchasable items.

6. The method of claim 1, wherein the trade between the first user and the second user is based on an identification of the second item by the first user as an item the first user is willing to trade for the first item.

7. The method of claim 1, wherein the trade between the first user and the second user is based on an identification by the first user that the second user is a user the first user would like to trade with.

8. The method of claim 1, wherein the first user receives a plurality of trade offers for the first item; and the method further comprises:
transferring, with the processor, the plurality of trade offers for the first item from the first user to the second user based on the trade between the first user and the second user of the first item for the second item.

9. The method of claim 1, further comprising:
receiving, with the processor, a counter-offer from the second user to the first user based on the trade between the first user and the second user, wherein the counter-offer comprises an additional item for the first user to provide in order to complete the trade between the first user and the second user; and
receiving, with the processor, an acknowledgement from the first user to complete the trade with the second user based on the counter-offer from the second user.

10. The method of claim 9, wherein the additional item comprises a virtual currency amount, the virtual currency being redeemable by the second user.

11. The method of claim 1, further comprising:
assigning, with the processor, a predetermined number of trades to the first user, wherein the predetermined number of trades is based on an initial purchase amount received from the first user;
increasing, with the processor, the number of trades assigned to the first user based on a second purchase amount received from the first user; and
decreasing, with the processor, the number of trades assigned to the first user based on the trade of the first item for the second item.

12. The method of claim 1, further comprising:
receiving a purchase amount from the first user to display a trade request with a predetermined feature for the second item; and displaying the trade request with the predetermined feature to the second user.

13. The method of claim 1, wherein the predetermined feature comprises displaying the trade request at a specified location on a display of the second user.

14. A system for trading merchandise, the system comprising:
an interface configured to receive communications from a plurality of users; and
a processor in communication with the interface, the processor being configured to:
assign a first plurality of items selected from an item inventory stored in a computer-readable memory to a plurality of users, wherein each user is assigned at least one item from the first plurality of items;
store item assignment data in the computer-readable memory, the item assignment data identifying which items of the first plurality of items are assigned to each of the plurality of users;
provide the interface to a first user of the plurality of users to trade a first item of the first plurality of items assigned to the first user with a second item of the first plurality of items assigned to a second user of the plurality of users;
update the item assignment data, stored in the computer-readable memory, to reassign the first item and the second item based on the trade between the first user and the second user; and
send a distribution request to distribute the plurality of items to the users to whom the first plurality of items are assigned as designated by the item assignment data.

15. The system of claim 14, wherein the distribution request to distribute the first plurality of items is sent after the close of a designated trading period.

16. The system of claim 14, wherein the at least one item assigned to the first user is designated by the first user to not be distributed to the first user, and instead be carried over to a next trading period.

17. The system of claim 14, wherein the processor is further configured to:
assign a second plurality of items selected from the item inventory to a first group of purchasable items, the first group of purchasable items having a discounted purchase price based on the total price of the first group of purchasable items;
assign the first group of purchasable items to the first user based on a request by the first user to purchase the first group of purchasable items; and
send a distribution request to distribute the items of the first group of purchasable items to the first user.

18. The system of claim 17, wherein the items of the first group of purchasable items are distributed to the first user after the close of a designated trading period, a length of the designated trading period being based on the discounted purchase price of the first group of purchasable items.

19. The system of claim 14, wherein the trade between the first user and the second user is based on an identification of the second item by the first user as an item the first user is willing to trade for the first item.

20. The system of claim 14, wherein the trade between the first user and the second user is based on an identification by the first user that the second user is a user the first user would like to trade with.

21. The system of claim 14, wherein:
the first user receives a plurality of trade offers for the first item; and
the processor is further configured to transfer the plurality of trade offers for the first item from the first user to the second user based on the trade between the first user and the second user of the first item for the second item.

22. The system of claim 14, wherein the processor is further configured to:
receive a counter-offer from the second user to the first user based on the trade between the first user and the second user, wherein the counter-offer comprises an additional item for the first user to provide in order to complete the trade between the first user and the second user; and
receive an acknowledgement from the first user to complete the trade with the second user based on the counter-offer from the second user.

23. The system of claim 22, wherein the additional item comprises a virtual currency amount, the virtual currency being redeemable by the second user.

24. The system of claim 14, wherein the processor is further configured to:
assign a predetermined number of trades to the first user, wherein the predetermined number of trades is based on an initial purchase amount received from the first user;
increase the number of trades assigned to the first user based on a second purchase amount received from the first user; and
decrease the number of trades assigned to the first user based on the trade of the first item for the second item.

25. The system of claim 14, wherein the processor is further configured to:
receive a purchase amount from the first user to display a trade request with a predetermined feature for the second item; and
display the trade request with the predetermined feature to the second user.

26. The system of claim 14, wherein the predetermined feature comprises displaying the trade request at a specified location on a display of the second user.
